(19) United States
(12) Patent Application Publication
(10) Pub. No.: US 2026/0178240 A1
(43) Pub. Date: Jun. 25, 2026

(54) IMAGE FORMING APPARATUS FOR FORMING IMAGE ACCORDING TO SHEET DESIGNATION INFORMATION INCLUDED IN PRINT JOB

(71) Applicant: KYOCERA Document Solutions Inc., Osaka (JP)

(72) Inventor: Daiki SONE, Osaka (JP)

(73) Assignee: KYOCERA Document Solutions Inc., Osaka (JP)

(21) Appl. No.: 19/417,271

(22) Filed: Dec. 11, 2025

(30) Foreign Application Priority Data
Dec. 19, 2024 (JP) 2024-224512

(51) Int. Cl. G06F 3/12

(52) U.S. Cl. CPC G06F 3/1205; G06F 3/1204; G06F 3/1206; G06F 3/1255; G06F 3/1257

(57) ABSTRACT

An image forming apparatus for a first purpose includes a sheet type conversion table configured to store a sheet type which is included in a print job to be used in an image forming apparatus for a second purpose different from the first purpose and designates a sheet type with fewer items than a sheet classification, in association with the sheet classification with a plurality of items, a sheet type converter configured to convert, when the sheet type is included in the print job for sheet designation, the sheet type into the sheet classification associated with the sheet type according to the sheet type conversion table, an image forming device that forms an image on a sheet, and a controller configured to cause the image forming device to form the image on the sheet according to the print job using the sheet classification converted by the sheet type converter instead of the sheet type included in the print job.

### INCORPORATION BY REFERENCE

This application claims priority to Japanese Patent Application No. 2024-224512 filed on December 19, 2024, the entire contents of which are incorporated by reference herein.

### BACKGROUND

The present disclosure relates to an image forming apparatus, and in particular, to a technique for forming an image on a sheet according to a print job in which a sheet classification is specified by a plurality of items.

In general, as a type of image forming apparatus, there are a production model and an office model. The production model is an image forming apparatus for industrial printing and prints printed matters (pamphlet, leaflet, and the like) that are uniquely produced by a company or an organization. On the other hand, the office model is an image forming apparatus for general printing and is provided in an office, a store, or the like.

The production model can print at a higher speed with higher image quality than the office model, and copes with printing of various sheet types (materials, surface treatment, and the like).

For example, a method that allows a user to easily select a type to be frequently used when a sheet type for an office model and a detailed sheet type for a production model are used has been proposed. A method that, when a storage device stores attribute information indicating attributes of recording mediums for each recording medium, and the storage device does not store attribute information of a recording medium designated by a print job, the storage device newly stores the attribute information and reduces a workload on an operator in registration processing for a recording medium has also been proposed.

Further, a method that, when a classification designated by a user and a classification including an attribute of a printing sheet set in a printing apparatus match each other among classifications of attributes of printing sheets to be used in the printing apparatus, allows the user to easily designate the attribute of the printing sheet by causing the printing apparatus to print according to the attribute has been proposed. In addition, a method that, even when catalog information is changed in one apparatus that uses the catalog information indicating various combinations of sheet attributes, can obtain a desired printing output result in another apparatus has also been proposed.

### SUMMARY

A technique improved over the above-described technique is proposed as one aspect of the present disclosure.

An image forming apparatus according to one aspect of the present disclosure is an image forming apparatus for a first purpose that forms an image on a sheet according to a print job in which a sheet classification is specified by a plurality of items determined in advance, and includes a first storage device, an image forming device, and a control device. The first storage device includes a sheet type conversion table configured to store a sheet type which is included in a print job to be used in an image forming apparatus for a second purpose different from the first purpose for sheet designation and designates a sheet type with fewer items than the sheet classification, in association with the sheet classification with the plurality of items having content corresponding to the sheet type. The image forming device forms an image on a sheet. The control device includes a processor, and when the processor executes a control program, functions as a sheet type converter and a controller. The sheet type converter is configured to convert, when the sheet type is included in the print job for sheet designation, the sheet type into the sheet classification associated with the sheet type according to the sheet type conversion table. The controller is configured to cause the image forming device to form an image on the sheet according to the print job using the sheet classification converted by the sheet type converter instead of the sheet type included in the print job.

### BRIEF DESCRIPTION OF THE DRAWINGS

FIG. 1 is a schematic view of a printing system.

FIG. 2 is a diagram illustrating an electrical configuration of a production model (an image forming apparatus for a first purpose).

FIG. 3 is a diagram illustrating an example of a sheet classification for a production model (an image forming apparatus for a first purpose).

FIG. 4 is a diagram illustrating an example of a sheet type for an office model (an image forming apparatus for a second purpose).

FIG. 5 is a diagram illustrating an example of a data configuration of a sheet type conversion table.

FIG. 6 is a flowchart illustrating an example of a flow of image forming processing of the production model (an image forming apparatus for a first purpose).

### DETAILED DESCRIPTION

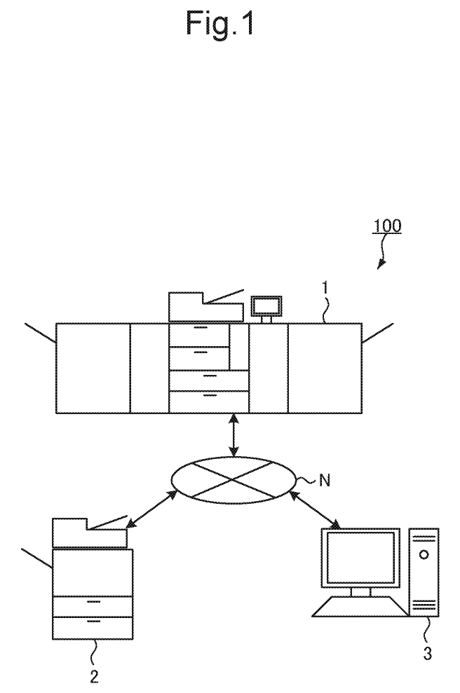

FIG. 1 is a schematic view of a printing system 100 including an image forming apparatus according to a present embodiment. The printing system 100 includes an image forming apparatus 1 for a first purpose, an image forming apparatus 2 for a second purpose, an electronic terminal 3, and a network N.

The image forming apparatus 1 (an image forming apparatus for a first purpose) is an image forming apparatus for a production model (for industrial printing) and prints printed matters (pamphlet, leaflet, and the like) that are uniquely produced by a company or an organization. That is, the image forming apparatus for a production model is an image forming apparatus for a first purpose. Hereinafter, while an example where the image forming apparatus 1 for a first purpose is an ink jet type recording apparatus will be described, the present disclosure is not limited thereto, and the image forming apparatus for a first purpose may also be an electrophotographic image forming apparatus.

The image forming apparatus 2 (an image forming apparatus for a second purpose) is an image forming apparatus for an office model (for general printing), is provided in an office, a store, or the like, and prints printed matters for an office purpose or intended to be used by a user himself/herself. That is, the image forming apparatus for an office model is an image forming apparatus for a second purpose. Hereinafter, while an example where the image forming apparatus 2 for a second purpose is an ink jet type recording apparatus will be described, the present disclosure is not limited thereto, and the image forming apparatus 2 for a second purpose may be an electrophotographic image forming apparatus. It should be noted that the image forming apparatus 1 for a first purpose and the image forming apparatus 2 for a second purpose use the same printing method.

Hereinafter, for ease of understanding, the image forming apparatus 1 is rephrased as a production model 1 and the image forming apparatus 2 is rephrased as an office model 2 in the following description.

The electronic terminal 3 is a personal computer, a tablet terminal, or the like, and transmits a print job to the production model 1 and the office model 2. The network N is a communication line such as a local area network (LAN) or the Internet through which data can be transmitted and received. A print job may be transmitted from a cloud server (not illustrated) or the like to the image forming apparatus 1 and the image forming apparatus 2.

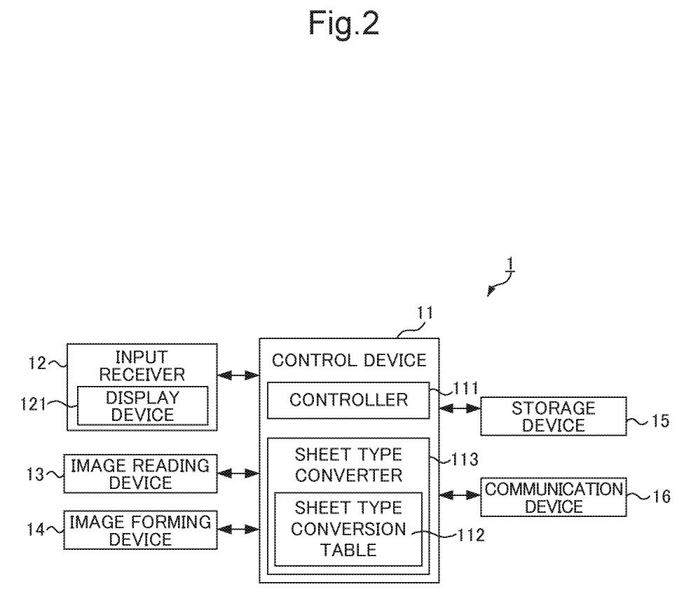

FIG. 2 is a diagram illustrating an electrical configuration of the production model 1. The production model 1 includes a control device 11, an input receiver 12, an image reading device 13, an image forming device 14, a storage device 15, a communication device 16, and the like.

The input receiver 12 includes hard keys such as an enter key and a start key to perform various operations or an operation to confirm settings, and a display device 121. The display device 121 includes, for example, a liquid crystal display (LCD) and displays an operation screen, a message, and the like. The display device 121 may be provided with a touch panel in an integrated manner.

The image reading device 13 includes, for example, a scanner, and reads an image of a document to acquire image data. The image forming device 14 is an ink jet type recording mechanism, and ejects ink on a sheet to print an image according to the image data acquired by the image reading device 13 or a print job received by the communication device 16 from an external apparatus or the like.

The storage device 15 is an HDD or an SSD, and is a large-capacity storage device that stores image data, various programs, data tables, and the like. The communication device 16 is composed of a communication module or the like, and transmits and receives various pieces of data to and from an external apparatus such as the office model 2 and the electronic terminal 3 via the network N.

The control device 11 is composed of a processor, a random access memory (RAM), a ROM, and the like. The processor is a central processing unit (CPU), a micro processing unit (MPU), an application specific integrated circuit (ASIC), or the like.

The control device 11 functions as a controller 111 and a sheet type converter 113 as the processor executes a control program stored in the ROM or the like. The controller 111 administers overall operation control of the production model 1. The sheet type converter 113 has a sheet type conversion table 112.

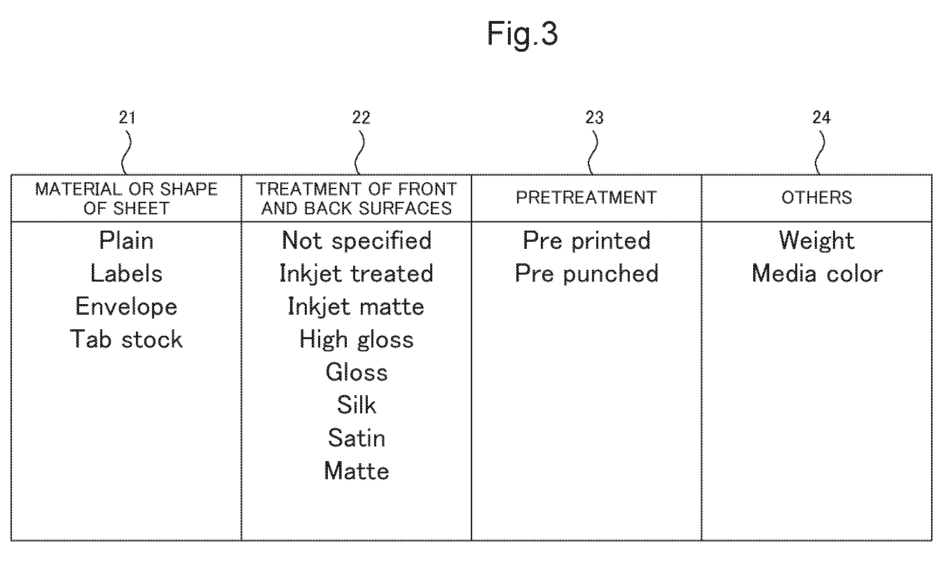

Before describing the sheet type conversion table 112, a sheet classification for the production model 1 will be described. In the following description, a sheet type that is information for designating a sheet type for the production model 1 is referred to as a sheet classification. FIG. 3 is a diagram illustrating an example of the sheet classification for the production model 1. As illustrated in FIG. 3, the sheet classification for the production model 1 is defined by a combination of a plurality of characteristic items (an example of items in the appended claims) 21, 22, 23, and 24. The characteristic items 21 to 24 are created based on sheet characteristics provided in a standard job definition format (JDF) in the industrial printing industry. In a print job for the production model 1, the sheet classification is specified by the plurality of characteristic items.

Specifically, the characteristic item 21 represents "material and shape of sheet", and is an item for defining the material or shape of the sheet. The characteristic item 22 represents "treatment of front and back surfaces", and is an item for defining the type of treatment applied to the front and back surfaces of the sheet. The characteristic item 23 represents "pretreatment", and is an item for defining the type of pretreatment applied to the sheet. The characteristic item 24 represents "other characteristics", and is an item for defining other characteristics such as the weight, color, or the like of the sheet.

For example, in the case of a preprinted thick sheet (200 gsm (g/m2)) treated for ink jet, the characteristic item 21 is defined as "Plain", the characteristic item 22 is defined as "Inkjet treated", the characteristic item 23 is defined as "Pre printed", and "Weight" in the characteristic item 24 is defined as "200 gsm".

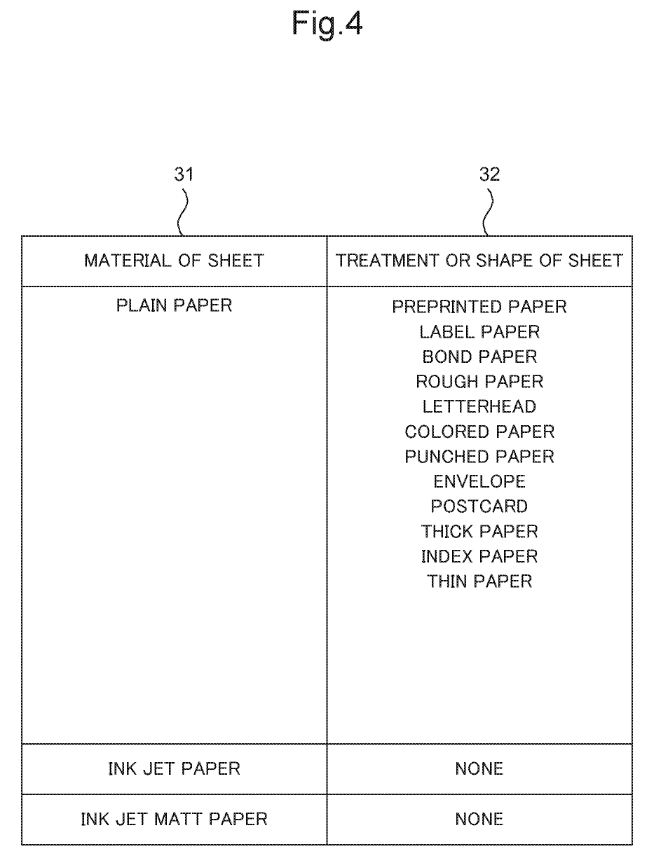

Next, the sheet type for the office model 2 will be described. FIG. 4 is a diagram illustrating an example of the sheet type for the office model 2. As illustrated in FIG. 4, the sheet type for the office model 2 defines a sheet type by combining characteristic items 31 and 32 simpler than in the case of the sheet classification.

Specifically, the characteristic item 31 represents "material of sheet", and is an item for defining the material of the sheet. For example, the material of the sheet is classified as plain paper, ink jet paper, or ink jet matt paper. The characteristic item 32 represents "treatment or shape of sheet", and is an item for defining the treatment or shape of the sheet. For example, the treatment or shape of the sheet is classified as preprinted paper, label paper, bond paper, rough paper, letterhead, colored paper, punched paper, envelope, postcard, thick paper, index paper, or thin paper.

In general, in the sheet type for the office model 2, only when the characteristic item 31 is "plain paper", a plurality of characteristic items 32 are set. When the characteristic item 31 is "ink jet paper" or "ink jet matt paper", the characteristic item 32 is not set. That is, in the sheet type for the office model 2, when a sheet other than plain paper is set, the treatment or shape of the sheet is not set in detail.

Accordingly, a print job in which a sheet type is designated by a sheet classification for a production model is transmitted to a general production model independent of the present embodiment. It is difficult for the production model to perform printing control according to a print job in which a sheet type is designated by a sheet type for an office model. Further, in the sheet type for an office model, when the characteristic item 31 is ink jet paper or ink jet matt paper, there is no characteristic item 32, and the sheet type cannot be designated in detail.

Accordingly, when a print job using a sheet type for an office model is transmitted to the general production model independent of the present embodiment, appropriate sheet selection is not performed, and appropriate ink jet head control is not performed.

Therefore, in the production model 1 according to the present embodiment, when the print job including the sheet type for the office model 2 is received via the communication device 16, the sheet type converter 113 changes the sheet type for the office model 2 included in the print job into a sheet classification for the production model 1 using the sheet type conversion table 112. The controller 111 causes the image forming device 14 to form an image on a sheet according to the print job using the sheet classification converted by the sheet type converter 113 instead of the sheet type included in the print job. With this, the production model 1 can select an appropriate sheet, perform appropriate control of the ink jet head, and maintain printing quality.

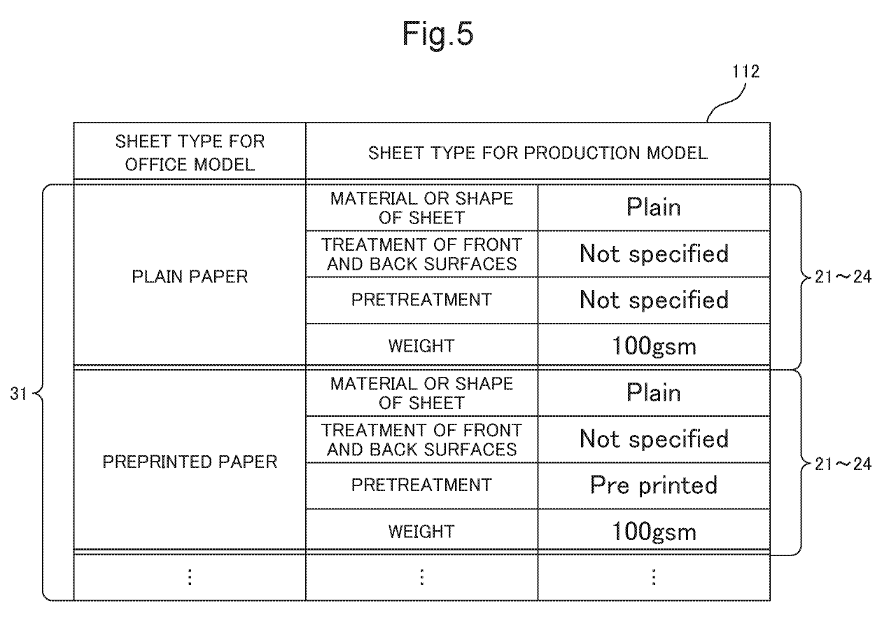

FIG. 5 is a diagram illustrating an example of a data configuration of the sheet type conversion table 112. The sheet type conversion table 112 stores "material of sheet" of the characteristic item 31 or "treatment or shape of sheet" of the characteristic item 32 indicating the sheet type for the office model 2 in association with the characteristic items 21 to 24 that compose the sheet classification for the production model 1.

When the production model 1 receives the print job using the sheet type for the office model 2 via the communication device 16, as described above, the sheet type converter 113 changes the sheet type for the office model 2 to the sheet classification for the production model 1 using the sheet type conversion table 112.

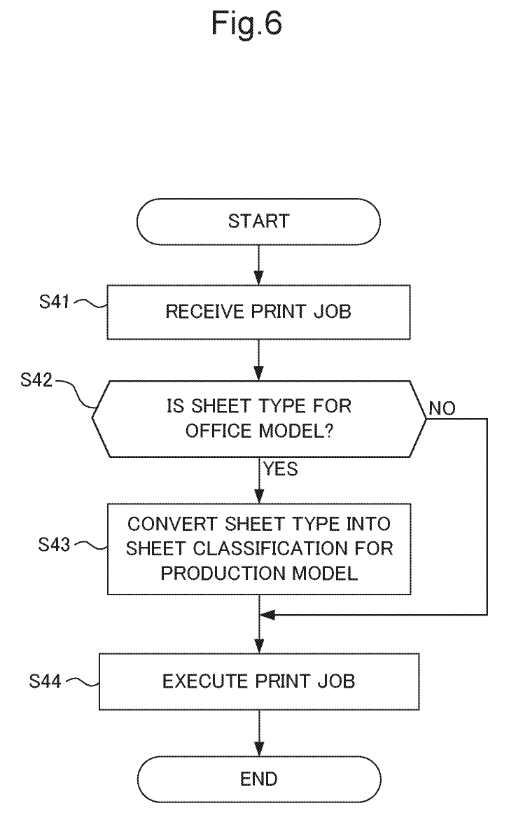

FIG. 6 is a flowchart illustrating an example of a flow of image forming processing of the production model 1. When the production model 1 receives a print job via the communication device 16 (S41), the controller 111 determines whether sheet designation information included in the print job is a sheet classification for a production model 1 or a sheet type for an office model 2 (S42). When the controller 111 determines that the sheet designation information is the sheet type for the office model 2 (S42; YES), the sheet type converter 113 changes the sheet type for the office model 2 included in the print job to the sheet classification for the production model 1 using the sheet type conversion table 112 (S43). The controller 111 causes the image forming device 14 to form an image on a sheet according to the print job using the sheet classification converted by the sheet type converter 113 instead of the sheet type included in the print job (S44). Thereafter, the processing ends.

On the other hand, when the controller 111 determines that the sheet designation information included in the print job is the sheet classification for the production model 1 (S42; NO), the controller 111 causes the image forming device 14 to form an image on a sheet according to the print job using the sheet classification included in the received print job (S44). Therefore, the processing ends.

As described above, when the print job in which the sheet type is designated by the sheet type for the office model 2 is received by the production model 1 via the communication device 16, the sheet type converter 113 changes the sheet type for the office model 2 to the sheet classification for the production model 1 using the sheet type conversion table 112. Accordingly, the production model 1 can normally perform printing control according to the print job. Therefore, even when printing control is performed according to the print job in which the sheet type is designated by the sheet type for the office model 2, it is possible to secure the printing quality of the production model 1.

In the production model 1, the sheet classification for the production model 1 is set for each of a plurality of sheet trays which are sheet feed cassettes in advance, and sheets corresponding to the set sheet classification are stored in each sheet tray. The controller 111 of the production model 1 causes the image forming device 14 to select a sheet tray according to the sheet classification for the production model 1 instructed by the print job, convey a sheet from the sheet tray, and form an image on the sheet.

In contrast, to allow the production model to execute a print job in which a sheet type is designated by a sheet type for an office model, a method that sets a sheet type for an office model to each of some sheet trays among a plurality of sheet trays in advance may be employed. In this case, the controller of the production model causes the image forming device to select a sheet tray according to the sheet type for the office model instructed by the print job, convey a sheet from the sheet tray, and form an image on the sheet. However, in this case, a user's operation is required to set the sheet type for the office model to the sheet tray, and labor is required.

According to the present embodiment, when the production model 1 receives the print job using the sheet type for the office model 2, the sheet type converter 113 converts the sheet type for the office model 2 included in the print job into the sheet classification for the production model 1. For this reason, the controller 111 performs control of selecting a sheet tray according to the converted sheet classification, conveying a sheet from the sheet tray, and forming an image on the sheet. Accordingly, the user does not need to additionally set the sheet type for the office model 2 to the sheet tray of the production model 1, and labor for the setting can be eliminated.

In general, because the production model places emphasis on printing quality compared to the office model, printing on various types of sheets (materials, surface treatment, and the like) is treated according to the kinds of printed matters. That is, the types of sheets for the production model are defined in more detail than the sheet type for the office model.

However, there is a case where a printing instruction is performed using a sheet type for an office model in the production model. In this case, in the production model, it is difficult to perform printing control with respect to a sheet designated by the sheet type for the office model, and sufficient printing quality cannot be secured.

While a plurality of methods that reduce a load on a user in selecting a sheet type are proposed, a technique that, even when a sheet type for an office model is set in a production model, enables printing control with respect to a sheet designated by the sheet type and secures sufficient printing quality is not disclosed.

In contrast, in the above-described embodiment, even in a different type of print job in which a sheet is designated in a different format from an original print job with elements determined in advance, it is possible to secure sufficient printing quality with respect to the sheet designated in the different format, and then, to execute printing control according to the different type of print job.

The present disclosure is not limited to the configuration of the above-described embodiment, and various modifications can be made. Further, in the above-described embodiment, the configuration and processing illustrated in the above-described embodiment using FIGS. 1 to 6 is merely an embodiment of the present disclosure, and the present disclosure is not intended to be limited to the configuration and processing.

While the present disclosure has been described in detail with reference to the embodiments thereof, it would be apparent to those skilled in the art that the various changes and modifications may be made therein within the scope defined by the appended claims.

What is claimed is:

1. An image forming apparatus for a first purpose that forms an image on a sheet according to a print job in which a sheet classification is specified by a plurality of items determined in advance, the image forming apparatus comprising:
a first storage device that stores a sheet type conversion table configured to store a sheet type which is included in a print job to be used in an image forming apparatus for a second purpose different from the first purpose for sheet designation and designates a sheet type with fewer items than the sheet classification, in association with the sheet classification with the plurality of items having content corresponding to the sheet type;
an image forming device that forms an image on a sheet; and
a control device that includes a processor, and when the processor executes a control program, functions as
a sheet type converter configured to convert, when the sheet type is included in the print job for sheet designation, the sheet type into the sheet classification associated with the sheet type according to the sheet type conversion table, and
a controller configured to cause the image forming device to form an image on the sheet according to the print job using the sheet classification converted by the sheet type converter instead of the sheet type included in the print job.

2. The image forming apparatus according to claim 1,
wherein, when determination is made that sheet designation information included in the print job is the sheet type, the sheet type converter is configured to change the sheet type to the sheet classification using the sheet type conversion table, and the controller is configured to cause the image forming device to form an image on the sheet according to the print job using the changed sheet classification, and
when determination is made that sheet designation information included in the print job is the sheet classification, the controller is configured to cause the image forming device to form an image on the sheet according to the print job using the sheet classification.

3. The image forming apparatus according to claim 1, further comprising:
a sheet feed cassette that stores a sheet; and
a second storage device that stores the sheet classification associated with the sheet feed cassette,
wherein the controller is configured to cause the image forming device to form an image on the sheet stored in the sheet feed cassette associated with the sheet classification converted by the sheet type converter according to the print job.
